(19) United States
(12) Patent Application Publication
(10) Pub. No.: US 2013/0227595 A1
(43) Pub. Date: Aug. 29, 2013

(54) METHODS AND APPARATUS TO IDENTIFY AUDIENCE MEMBERS

(71) Applicants: Christen V. Nielsen, Palm Harbor, FL (US); Kevin Keqiang Deng, Safety Harbor, FL (US)

(72) Inventors: Christen V. Nielsen, Palm Harbor, FL (US); Kevin Keqiang Deng, Safety Harbor, FL (US)

(21) Appl. No.: 13/472,269

(22) Filed: May 15, 2012

Related U.S. Application Data
(60) Provisional application No. 61/603,080, filed on Feb. 24, 2012.

(51) Int. Cl. H04N 21/258

(52) U.S. Cl. 725/11

(57) ABSTRACT

Methods and apparatus are disclosed to identify audience members. An example method includes detecting selection an identification key on a remote control. The identification key is input by a user using an input on the remote control. The remote control is to control a consumer electronic device. The example method includes generating an audio signal to identify the user based on the identification key. The audio signal is electronically detectable. The example method includes outputting the audio signal via a speaker.

### RELATED APPLICATION

This patent claims priority to U.S. Provisional Application Ser. No. 61/603,080, entitled “Methods and Apparatus to Identify Audience Members,” which was filed on Feb. 24, 2012, and is hereby incorporated herein by reference in its entirety.

### FIELD OF THE DISCLOSURE

This patent relates generally to audience measurement, and, more particularly, to methods and apparatus to identify persons in an audience.

### BACKGROUND

Audience measurement of media, such as television and/or radio programs and/or advertisements, is typically carried out by monitoring media exposure of panelists that have been statistically selected to represent particular demographic groups. Audience measurement entities collect audience measurement data. Audience measurement data includes media data (e.g., data reflecting the identity of media (e.g., programming and/or advertisements) to which an audience has been exposed) and people meter data (e.g., data identifying persons who have been exposed to the content). Using various statistical methods, the collected audience measurement data is processed to determine the size and demographic composition of the audience(s) for media of interest. The audience size and demographic information is valuable to advertisers, broadcasters and/or other entities. For example, audience size and demographic information is a factor in the placement of advertisements, as well as a factor in valuing commercial time slots during particular programs.

### BRIEF DESCRIPTION OF THE DRAWINGS

FIG. 1 illustrates an example audience measurement system including an example remote control implemented in accordance with the teachings of this disclosure to provide audio-based remote control communication.

FIG. 2 illustrates an example implementation of the remote control of FIG. 1.

FIG. 3 illustrates another example implementation of the remote control of FIG. 1.

FIG. 3A illustrates an example table which may be used by the example remote control of FIG. 3.

FIG. 4 illustrates another example implementation of the remote control of FIG. 1.

FIG. 5 illustrates an example implementation of the meter of FIG. 1.

FIG. 6 is a flow diagram representative of example machine readable instructions that may be executed to implement the example remote control of FIG. 2.

FIG. 7 is a flow diagram representative of example machine readable instructions that may be executed to implement the example remote control of FIG. 3.

FIG. 8 is a flow diagram representative of example machine readable instructions that may be executed to implement the example remote control of FIG. 4.

FIG. 9 is a flow diagram representative of example machine readable instructions that may be executed to implement the example meter of FIG. 5.

FIG. 10 is another flow diagram representative of other example machine readable instructions that may be executed to implement the example meter of FIG. 5.

FIG. 11 is a block diagram of an example processor platform that may be used to execute the instructions of FIGS. 6, 7, 8, 9, and/or 10 to implement the example remote control of FIG. 2, the example remote control of FIG. 3, the example remote control of FIG. 4, the example meter of FIG. 5, and/or, more generally, the example system of FIG. 1.

### DETAILED DESCRIPTION

Audience measurement companies enlist persons to participate in measurement panels. Such persons agree to allow the audience measurement company to measure their exposure to media (e.g., television, radio, Internet, advertising, signage, outdoor advertising, etc.) using, for example, a meter. In order to properly credit media with an audience exposure, the audience measurement company tracks the identity of the person (i.e., panelist) exposed to media. This tracking has traditionally been accomplished with a people meter. People meters have either required users to self-identify by, for example, pressing a button on a dedicated people meter which is stationed on, for example, a coffee table or other surface in the media presentation area, or have attempted to identify the audience member via another mechanism such as facial recognition. In some examples, people meters are unable to interface with meters collecting media exposure data.

Example methods, systems, and/or article of manufacture disclosed herein identify an audience member via a person identifier (e.g., an identification key) received via a remote control which is also used to control a consumer electronic (e.g., a media presentation) device such as a television, set top box, digital versatile disc (DVD) player, Blu-ray player, etc. In some examples, the identifier (e.g., an alphanumeric identifier) is input by a user using one or more push buttons on the remote control. In some such disclosed examples, the remote control generates and transmits a free field audio signal within a monitored site based on the identifier (e.g. containing information identifying a person identified by the person identifier). Some such disclosed examples include outputting the audio signal via a speaker.

Some disclosed example methods include decoding a first audio signal received from a people meter (e.g., which may be a remote control) to determine an identifier associated with a user. Some such disclosed example methods include decoding a second audio signal received from a media presentation device to identify media displayed via the media presentation device. In some examples, the first audio signal provides an interface between the people meter and a meter decoding the second audio signal to identify media displayed via the media presentation device. Some such disclosed example methods include transmitting an identifier of the user and an identifier of the media to a central data facility to facilitate crediting exposure to the media to the user. In some examples, the people meter is implemented by a remote control which also functions to control an information presentation device (e.g., a consumer electronic device such as a television, set top box, etc.).

Some disclosed example systems include a remote control to detect an identifier (e.g., an identification key) input by a user using one or more push buttons. In some such disclosed example systems, the remote control generates an audio signal to identify the user based on the identifier. In some such disclosed example systems, the remote control outputs the audio signal via a speaker. The audio signal can be detected and decoded to identify the user.

Some disclosed example systems include a people meter to detect an identifier (e.g., an identification key) input by a user using one or more push buttons. In some such disclosed example systems, the people meter generates a free field audio signal based on the identifier and transmits the free field audio signal via a speaker. The audio signal can be detected and decoded to identify the user. In some examples, the people meter is implemented by a remote control which also functions to control an information presentation device such as a television, set top box, etc.

Some disclosed example systems include a meter to decode a first audio signal received from a people meter to determine an identifier associated with a user. In some such disclosed example systems, the meter decodes a second audio signal received from an information and/or media presentation device to identify media displayed via the media presentation device. In some such disclosed example systems, the meter transmits an identifier of the user and an identifier of the media to a central data facility. One or both of the identifiers may be timestamped to facilitate crediting of the exposure of the panelist to the media.

Some disclosed example tangible computer-readable storage media include instructions that, when executed, cause a people meter to at least detect an identifier (e.g., an identification key) input by a user using one or more push buttons on a people meter (e.g., which may be implemented as a remote control of a consumer electronic device). The instructions of some such examples cause the people meter to generate an audio signal based on the identifier. The instructions of some such examples cause the people meter to output the audio signal via a speaker. The audio signal is decodable to identify the user that input the identifier.

Some disclosed example tangible computer-readable storage media include instructions that, when executed, cause a computing device to at least decode a first audio signal received from a people meter to determine an identifier associated with a user. The instructions of some such examples cause the computing device to decode a second audio signal received from a media presentation device to identify media displayed via the media presentation device. The instructions of some such examples cause the computing device to transmit an identifier of the user and an identifier of the media to a central data facility.

Example audio-based remote controls disclosed herein enable identification of a user so that the user may be associated with media to which the user is exposed. In disclosed examples, a meter is located in a household to collect audience measurement data. For example, a media presentation device (e.g., a television) may be monitored by the meter to determine media that is presented via the media presentation device. In disclosed examples, a user enters an identifier using an example remote control. The identifier may be assigned to the user by an audience measurement company. Example remote controls disclosed herein transmit audio signals to the meter representative of the identifier(s) input by users. Meters disclosed herein use the received audio signals to associate data identifying presented media with users exposed to such media.

In some disclosed examples, the remote control uses dual-tone multi-frequency (DTMF) signaling to transmit an audio signal representative of the identifier of the user to the meter. DTMF signaling involves the generation of a unique combination of frequencies for each number one through nine on an example remote control. In such disclosed examples, the remote control transmits a DTMF signal that is decoded by the meter to determine the identifier entered by the user.

In some disclosed examples, the remote control uses watermarking technology to transmit an audio signal carrying codes representative of the identifier of the user to the meter. In such disclosed examples, each identifier is associated with an identification code that the remote control embeds into an audio signal to be transmitted to the meter. In such disclosed examples, the remote control transmits a watermarked signal that is decoded by the meter to determine the identifier associated with the user.

In some disclosed examples where watermarking technology is used to transmit the identifier in audio signals, the remote control accounts for other audio signals containing watermarks (e.g., codes) that may be present in the metered household. For example, a media presentation device may output signals containing media identification codes that are broadcast with the media being presented to identify the media presented at the media presentation device. In such examples, the meter collects signals with embedded codes from both the media presentation device and the remote control. If the same coding scheme is being used, the codes in the media and the codes used for people metering could potentially interfere. To avoid and/or prevent any such collision in the codes (e.g., simultaneous transmission resulting in interference between the codes), the remote control of some disclosed examples detects the presence of media identification codes in audio signals output by the media presentation device and transmits its own audio signals containing people identification code(s) at times when media identification codes are not expected to be transmitted. In some examples, the media identification codes are transmitted at known intervals (e.g., every 2.5 seconds). The remote control of such examples may use such known intervals to determine a time at which a media identification code is not expected and transmit the people identification code(s) at such times.

In some disclosed examples, the meter prompts the user to input their user identifier. To prompt the user, the meter may use flashing lights or verbal instructions, for example. In some examples, the meter prompts the user to input the identifier periodically or aperiodically. In some examples, the meter prompts the user upon the occurrence of an event. The event may be, for example, when the meter detects a change in a television channel, a volume change, a source change (e.g., changing from the television (TV) viewing to DVD viewing), a change of state in a connected device (e.g., when a gaming system connected to a television is pressed on), a source change, etc. In some disclosed examples, the meter provides the user with a login confirmation after the user has entered the identifier. The login confirmation may be, for example, a message on the information presenting device, flashing lights or a verbal confirmation.

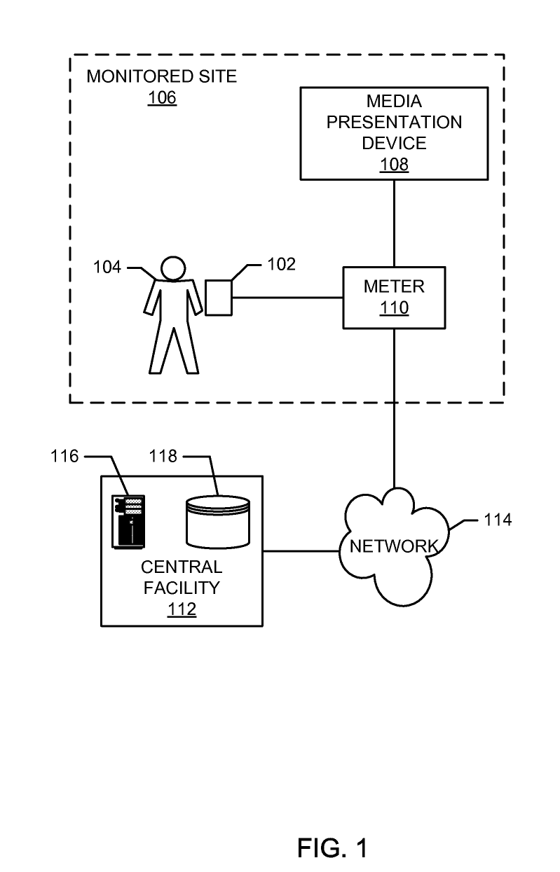

FIG. 1 illustrates an example remote control 102 implemented in accordance with the teachings of this disclosure to identify a user 104 (e.g., an audience member) at a monitored site 106 that is exposed to media presented by a media presentation device 108. In the illustrated example, the remote control 102, the user 104, the media presentation device 108, and a meter 110 are located in the monitoring site 106. The home monitoring site 106 of the illustrated example is a household of a panelist that has volunteered, has been selected and/or has agreed to participate in an audience measurement study (e.g., residents of the household have agreed to the monitoring of their media exposure activity).

In the illustrated example, the meter 110 is located at the monitored site 106 to collect media identification information and/or to perform local processing of information collected from the example remote control 102, the media presentation device 108, and/or any other device used to collect audience measurement data. For example, if the media presentation device 108 outputs a media signal, the meter 110 may process the media signal (or a portion thereof such as an audio portion of the media signal) to extract codes and/or metadata, and/or to generate signatures for use in identifying the media and/or a station transmitting the media.

Identification codes, such as watermarks, ancillary codes, etc. may be embedded within media signals. Identification codes are data that are inserted into media (e.g., audio) to uniquely identify broadcasters and/or media (e.g., content or advertisements), and/or are carried with the media for another purpose such as tuning (e.g., packet identifier headers (“PIDs”) used for digital broadcasting). Codes are typically extracted using a decoding operation.

Signatures are a representation of some characteristic of the media signal (e.g., a characteristic of the frequency spectrum of the signal). Signatures can be thought of as fingerprints. They are typically not dependent upon insertion of identification codes in the media, but instead preferably reflect an inherent characteristic of the media and/or the media signal. Systems to utilize codes and/or signatures for audience measurement are long known. See, for example, Thomas, U.S. Pat. No. 5,481,294, which is hereby incorporated by reference in its entirety.

The media presentation device 108 may be any consumer electronic device such as, for example, a television, a radio, a computer, a stereo system, a DVD player, a game console, etc. In the illustrated example, one media presentation device 108 is shown. However, a plurality of media presentation devices may be included and/or monitored at the monitored site 106. In some examples, the media presentation device 108 and the meter 110 are connected using wired connections. In some examples, the meter 110 monitors the media presentation device 108 wirelessly. Similarly, although only one monitored site 106 is shown, the system may monitor many more sites.

The remote control 102 of the illustrated example is structured to control the operation of one or more consumer electronic devices as well as to aid in the collection and/or processing of audience measurement data obtained at the monitored site 106. In the illustrated example, the remote control 102 is used to identify and/or verify the identity of an audience member (e.g., the user 104) so that the media identification data collected by the example meter 110 and identifying the media presented by the media presentation device 108 is associated with the appropriate audience member to enable correlation of audience demographics to the media exposure. For example, the meter 110 may determine that a certain television program was displayed on the media presentation device 108 and the remote control 102 may be used to determine that a certain audience member was exposed to the television program.

To determine the identity of the user 104, the user 104 of the illustrated example inputs (e.g., enters) an identifier (e.g., identification key) using an input device being (such as one or more of a plurality of push buttons) on the remote control 102. The identifier input by the user 104 is used to uniquely identify an audience member that is being exposed to media at the media presentation device 108. The identifier may be, for example, any series of numbers that has been assigned to the user 104. For example, a list may be stored in the meter 110 and/or a central facility 112 that contains identifiers recorded for household members (e.g., including the user 104) and their associated identifiers.

The user 104 may voluntarily input his/her identifier at any time and/or the user 104 may be prompted to input his/her identifier. In the illustrated example, the meter 110 prompts the user 104 to input his/her identifier. The meter 110 may prompt the user 104 by emitting, for example, an audio signal containing audible instructions to input the identifier. In some examples, the meter 110 utilizes flashing light emitting diodes (LEDs) to prompt the user 104 to input the identifier. The prompt may be, for example, instructions, an audio musical note sequence (e.g., a jingle), flashing lights, a tactile sensation (e.g., a vibration in the remote 102), and/or any other notification technique with which to prompt a user. The meter 110 may prompt the user 104 to input his/her identifier periodically, aperiodically, and/or upon an occurrence of an event. Such events may include, for example, a change in a television channel, a volume change, a change in a device being used (e.g., switching from use of a set top box (STB) to use of a gaming system), and/or any other event that may indicate a change in audience composition. Once an identifier has been entered by the user 104, the meter 110 of the illustrated example outputs a confirmation informing the user 104 that the identifier was received. The confirmation may be an output similar or different to the user prompt. For example, the confirmation may be a jingle, flashing lights, a tactile sensation (e.g., a vibration in the remote 102), and/or any other notification technique with which to inform the user that the identifier was received.

In the illustrated example, the remote control 102 generates an audio signal to transmit the identifier input by the user 104 to the meter 110. The remote control 102 transmits the audio signal via a speaker to communicate the identifier to the meter 110. In some examples, the remote control 102 generates a dual-tone multi-frequency (DTMF) signal to be transmitted to the meter 110. In such examples, each push button depressed by the user 104 on the remote control 102 corresponds to a specific DTMF signal that is generated and output by the remote control 102. The DTMF signal output by the remote control 102 is audible by humans (e.g., the user 104).

In some examples, the remote control 102 generates an audio signal that is representative of and/or is modulated to include identification code(s) (e.g., watermark(s)) representative of the identifier input by the user 104. In such examples, the remote control 102 stores a table correlating identifiers to their associated identification codes. Once a user 104 inputs an identifier, the remote control 102 determines the identification code associated with the identifier and embeds (e.g., encodes) this identification code into an audio signal to be transmitted to the meter 110. The identification code within the audio signal generated by the remote control 102 is electronically detectable (e.g., may be received and decoded by the meter 110), but is imperceptible to humans (e.g., the user 104 cannot hear the identification code in the audio signal when it is transmitted). The audio signal output by the remote control 102 is audible by humans (e.g., the user 104). In some examples, the watermark used for the identification codes is a Nielsen NAES code as described in, for example, U.S. patent application Ser. No. 12/249,619, which is hereby incorporated by reference.

In some examples, the watermarked signals (e.g., the audio signals containing the identification codes) transmitted by the remote control 102 may be similar to watermarked audio signals output by the media presentation device 108. In particular, television programming, advertisements, and/or other media are often transmitted with audio watermarks to facilitate identification of the associated media for audience measurement and/or other purposes. These watermarks are collected by the meter 110 to identify media output by the media presentation device 108. For example, Nielsen encoders (e.g., NAES encoders) operated by a television broadcaster will embed a code into the media being broadcast every 2.5 seconds. In such examples, a media identification code is expected to be included in audio presented by a media presentation device 108 tuning such encoded media every 2.5 seconds. To avoid and/or prevent collision and/or interference between the media identification codes in the media and the person identification code(s) output by the remote control 102, the remote control 102 of the illustrated example transmits watermarked audio signals during times in which a media identification code is not expected to be present in the signal being output from the media presentation device 108 (e.g., during intervals within the 2.5 seconds between media identification codes). To this end, the remote control 102 of the illustrated example includes a sensor to receive free field audio signals (e.g., audio signals output by the media presentation device 108) and a decoder to decode the signals to detect the presence of a media identification code within the signal. The remote control 102 of some such examples includes a timer to determine a time at which media identification codes are not expected in the signals output by the media presentation device 108 and transmits its watermarked people identification signals during such times. In such examples, the same types of codes are used by the broadcast encoder and the encoder of the remote control 102. Thus, the meter 110 includes a sensor (e.g., microphone) to receive signals from the remote control 102 and from the media presentation device 110. The people identification codes used by the remote control 102 are reserved for audience member identification and, thus, the meter 110 may distinguish between media identification codes received to identify media and people identification codes received to identify audience members. In some examples, the people identification codes are sent with a higher power than the media identification codes to aid the meter 110 in distinguishing between the people identification codes and the media identification codes. In some examples, if some media identification codes are not received and/or properly decoded due to receipt of people identification codes, some processing may be performed to identify some of the media identification codes that were not received and/or not properly decoded. For example, a media identification code that was not received and/or not properly decoded may be assumed to be the same as the last received and/or properly decoded media identification code. In some examples, different encoding/decoding schemes (e.g., different frequencies, different code types) are used to distinguish the audio signals transmitted by the remote control 102 from the audio signals transmitted by the media presentation device 108.

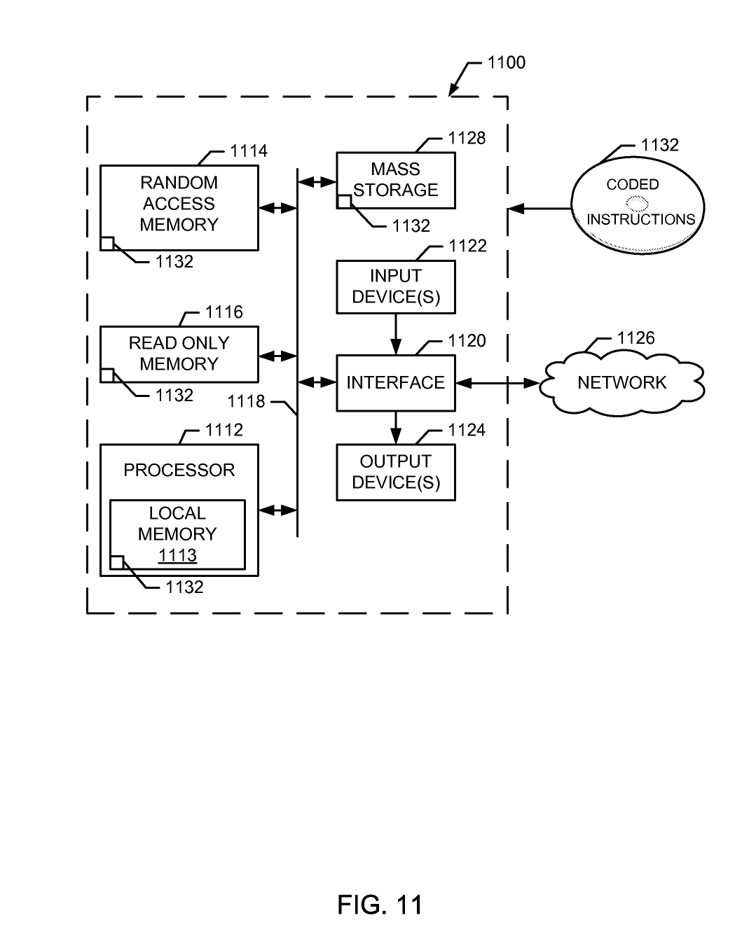

The meter 110 of the illustrated example processes the audience measurement data locally and/or transfers the collected data to the remotely located central data facility 112 via the network 114 for processing and/or further processing if some degree of local processing is performed. The central facility 112 of the illustrated example collects and/or stores, for example, media exposure data, media monitoring data, person identification data and/or demographic information that is collected by multiple media monitoring devices such as, for example, the remote control 102 and/or the meter 110 associated with multiple different monitored sites. The central facility 112 may be, for example, a facility associated with The Nielsen Company (US), LLC or any affiliate of The Nielsen Company (US), LLC. The central facility 112 of the illustrated example includes a server 116 and a database 118 that may be implemented using any suitable processor, memory and/or data storage apparatus such as that shown in FIG. 11.

The network 114 of the illustrated example is used to communicate information and/or data between the example meter 110 and the central facility 112. The network 114 may be implemented using any type of public and/or private network such as, but not limited to, the Internet, a telephone network (e.g., the plain old telephone system (POTS) network), a local area network (“LAN”), a cable network, a cellular network, and/or a wireless network. To enable communication via the network 114, the meter 110 of the illustrated example includes a communication interface that enables connection to an Ethernet, a digital subscriber line (“DSL”), a telephone line, a coaxial cable, and/or any wireless connection, etc. Although only one monitored site 106 is shown in FIG. 1, the example system of FIG. 1 includes many such sites. Similarly, the example sites may include more than one central facility serving different geographic regions, different studies, etc.

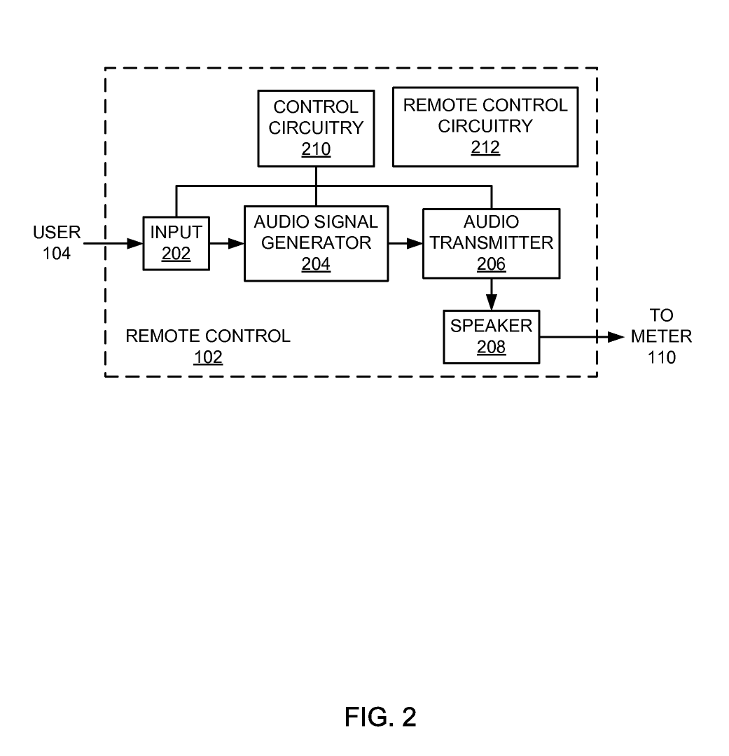

FIG. 2 is a block diagram of an example implementation of the remote control 102 of FIG. 1. In the illustrated example, the remote control 102 aids in the collection of people meter data at a monitored site (e.g., the monitored site 106). The remote control 102 may be used as a people meter to identify the audience member(s) and/or may be used to verify the identity of audience member(s) (e.g., the user 104) to support or supplement data collected by another people meter in the monitored site 106. The remote control 102 of the illustrated example utilizes DTMF signals to transmit identifiers to the meter 110. In the illustrated example, the remote control 102 includes an input 202, an audio signal generator 204, an audio transmitter 206, a speaker 208, control circuitry 210, and remote control circuitry 212.

The input 202 of the illustrated example allows the user 104 to input an identifier. The identifier of the illustrated example is a unique series of numbers and/or letters that identifies a particular user 104 and allows the user 104 to be associated with content data collected from the media presentation device 108. The input 202 of the illustrated example is a set of push buttons on the remote control 102 that, when depressed, indicate a certain number is being entered. The identifier entered by the user 104 via the input 202 is then passed to the audio signal generator 204. The identifier entered by the user may identify the user 104 or another member of the audience. Each of the inputs may be mapped to a specific household member such that only one button is pushed to identify a member (e.g., a member A), even if the identifier for that user (e.g., member A) includes multiple digits or characters.

The audio signal generator 204 of the illustrated example is implemented by a DTMF generator that generates a DTMF signal (e.g., a tone) representative of some or all of the identifier entered into the input 202. In the illustrated example, when a push button is depressed on the input 202 of the remote control 102, the audio signal generator 204 generates two tones simultaneously. For each number one through nine on the push buttons of the remote control 102, the audio signal generator 204 generates a unique combination of signals that allows a meter (e.g., the meter 110) to identify the number that was entered. The signal generated by the audio signal generator 204 is representative of some or all of the identifier entered and/or selected by the user 104 and is output by the audio transmitter 206 of the illustrated example. The audio transmitter 206 of the illustrated example uses the speaker 208 to transmit the audio signals to be received at the meter 110. The DTMF signal is modulated on a carrier wave for transmission to the meter 110 as an audio signal. The frequency of the transmitted audio signal of the illustrated example is selected to be outside the human auditory range but to be detectable with a microphone.

In the illustrated example, the control circuitry 210 controls the operations of the remote control 102. For example, the control circuitry 210 controls and/or responds to the input 202, the audio signal generator 204, and/or the audio transmitter 206 of the remote control 102 to allow the user 104 to input the identifier(s) and to transmit signal(s) representative of the input identifier(s). Because the generated signals of the illustrated example are DTMF signals, the remote control 102 of the example of FIG. 2 may transmit the generated signals at any time, regardless of the presence of content codes in signals output by the media presentation device 108. The remote control circuitry 212 of the illustrated example controls one or more consumer electronics (e.g., a TV, gaming system, stereo, etc.) with infrared or other (e.g., Bluetooth) signals. The remote control circuitry 212 allows the remote control 102 to operate as a standard remote control while the remote control 102 also aids in the collection of people meter data.

While an example remote control 102 has been illustrated in FIG. 2, one or more of the elements, processes and/or devices illustrated in FIG. 2 may be combined, divided, re-arranged, omitted, eliminated and/or implemented in any other way. Further, the input 202, the audio signal generator 204, the audio transmitter 206, the speaker 208, the control circuitry 210, the remote control circuitry 212, and/or, more generally, the example remote control 102 of FIG. 2 may be implemented by hardware, software, firmware and/or any combination of hardware, software and/or firmware. Thus, for example, any of the example input 202, the audio signal generator 204, the audio transmitter 206, the speaker 208, the control circuitry 210, the remote control circuitry 212, and/or, more generally, the example remote control 102 of FIG. 2 could be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc. When any of the apparatus or system claims of this patent are read to cover a purely software and/or firmware implementation, at least one of the example input 202, the audio signal generator 204, the audio transmitter 206, the speaker 208, the control circuitry 210, and/or the remote control circuitry 212 are hereby expressly defined to include a tangible computer readable medium such as a memory, DVD, compact disc (“CD”), Blu-ray, etc. storing the software and/or firmware. Further still, the example remote control 102 of FIG. 2 may include one or more elements, processes and/or devices in addition to, or instead of, those illustrated in FIG. 2, and/or may include more than one of any or all of the illustrated elements, processes and devices.

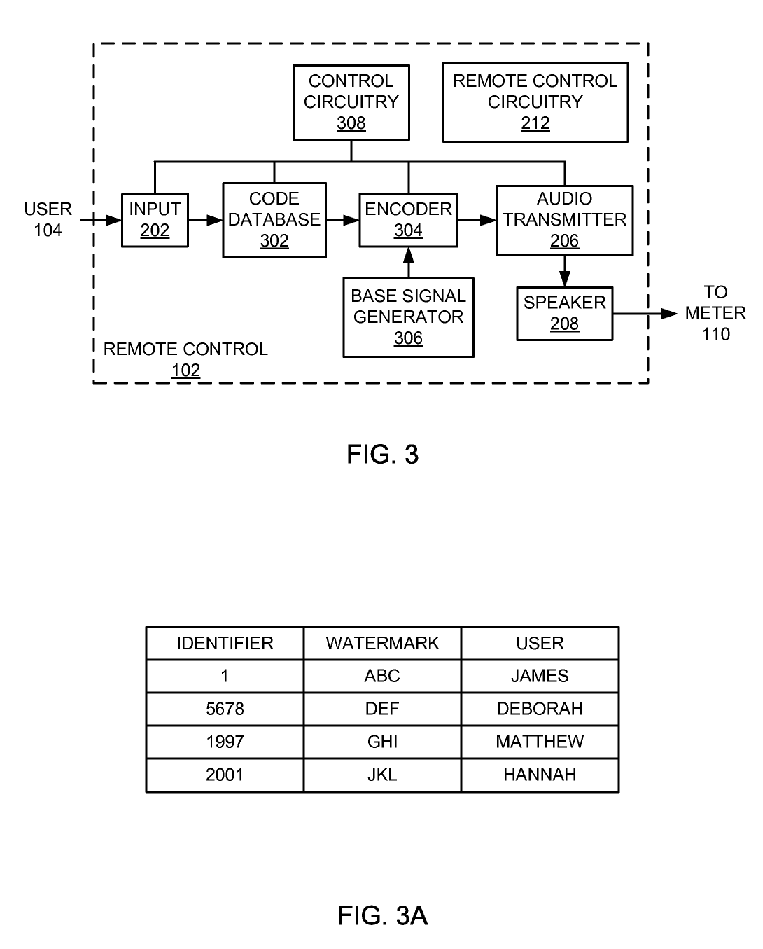

FIG. 3 is a block diagram of another example implementation of the remote control 102 of FIG. 1. The example remote control 102 of FIG. 3 uses watermarking technology to transfer people identification data useful for people metering. In the illustrated example, the remote control 102 includes the input 202, the audio transmitter 206, the speaker 208, the remote control circuitry 212, a code database 302, an encoder 304, a base signal generator 306, and control circuitry 308.

The example remote control 102 of FIG. 3 has elements similar to counterpart elements in the example remote control 102 of FIG. 2. For example, the input 202, the audio transmitter 206, the speaker 208, and the remote control circuitry 212 are similar to their counterparts in the example of FIG. 2. Elements numbered with like reference numbers are substantially similar and/or identical and, thus, are not redescribed in detail here. Instead, the interested reader is referred to the above descriptions of the like numbered elements for a full and complete description of the same.

The code database 302 of the illustrated example maps identifiers (e.g., user identifiers) to their associated people identification codes (e.g., watermarks). For example, an identifier is assigned to each user (e.g., the user 104) and a person identification code is assigned to each identifier. An example table which may be stored in the code database 302 to map identifiers to watermarks to users/panelists is shown in FIG. 3A. The code database 302 of the illustrated example is used to look up the identification codes/watermarks corresponding to the identifier entered by or selected by the user 104 via the input 202. This identification code is passed to the encoder 304.

The encoder 304 of the illustrated example encodes (e.g., embeds, mixes, inserts, etc.) the person identification code (e.g., watermark) into an audio carrier signal that is obtained from the base signal generator 306. In the illustrated example, the carrier signal is implemented as white noise to reduce audibility to users. In some examples, other sounds (e.g., a jingle) may be used to further reduce audibility of the person identification codes to users. The encoder 304 may be implemented in any desired form. The encoding may be done in the frequency domain or the time domain and may be achieved using a mixer to combine the code with the audio baseband signal. This watermarked signal (e.g., an audio signal containing the identification code) output by the encoder 304 is passed to the audio transmitter 206 to be transmitted to a meter (e.g., the meter 110) via the speaker 208.

The control circuitry 308 of the illustrated example controls the operations of the remote control 102. For example, the control circuitry 308 controls the input 202, the code database 302, the encoder 304, the base signal generator 306, and/or responds to the audio transmitter 206 of the remote control 102 to respond to input or selection of an identifier by the user 104 by transmitting a signal representative of that identifier.

While the structure of an example remote control 102 has been illustrated in FIG. 3, one or more of the elements, processes and/or devices illustrated in FIG. 3 may be combined, divided, re-arranged, omitted, eliminated and/or implemented in any other way. Further, the input 202, the audio transmitter 206, the speaker 208, the remote control circuitry 212, the code database 302, the encoder 304, the base signal generator 306, the control circuitry 308, and/or, more generally, the example remote control 102 of FIG. 3 may be implemented by hardware, software, firmware and/or any combination of hardware, software and/or firmware. Thus, for example, any of the example input 202, the audio transmitter 206, the speaker 208, the remote control circuitry 212, the code database 302, the encoder 304, the base signal generator 306, the control circuitry 308, and/or, more generally, the example remote control 102 of FIG. 3 could be implemented by one or more circuit(s), programmable processor(s), ASIC(s), PLD(s) and/or FPLD(s), etc. When any of the apparatus or system claims of this patent are read to cover a purely software and/or firmware implementation, at least one of the example input 202, the audio transmitter 206, the speaker 208, the remote control circuitry 212, the code database 302, the encoder 304, the base signal generator 306, and/or the control circuitry 308 are hereby expressly defined to include a tangible computer readable medium such as a memory, DVD, CD, Blu-ray, etc. storing the software and/or firmware. Further still, the example remote control 102 of FIG. 3 may include one or more elements, processes and/or devices in addition to, or instead of, those illustrated in FIG. 3, and/or may include more than one of any or all of the illustrated elements, processes and devices.

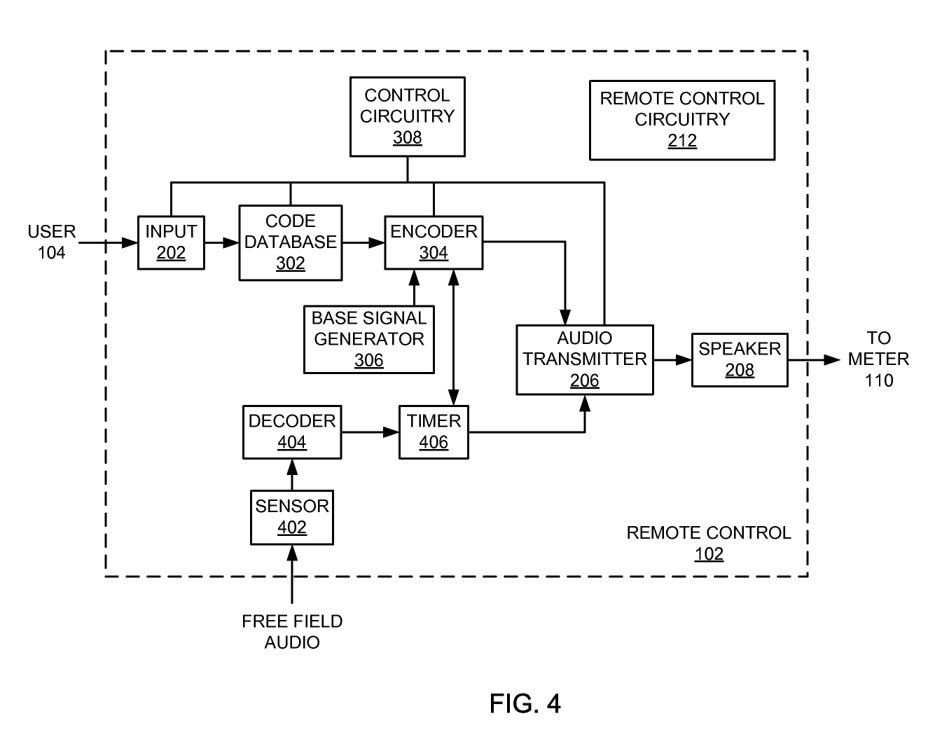

FIG. 4 is a block diagram of another example implementation of the remote control 102 of FIG. 1. The example remote control 102 of FIG. 4 uses watermarking technology for transferring people metering data to a meter and detects the presence of content codes in audio output by a media presentation device (e.g., the media presentation device 108) for the purpose of determining timing of the transmission of people metering data. In the illustrated example, the remote control 102 includes the input 202, the audio transmitter 206, the speaker 208, the remote control circuitry 212, the code database 302, the encoder 304, the base signal generator 306, control circuitry 308, a sensor 402, a decoder 404, and a timer 406.

The example remote control 102 of FIG. 4 has elements similar to counterpart elements in the example remote control 102 of FIG. 3. For example, the input 202, the audio transmitter 206, the speaker 208, the remote control circuitry 212, the code database 302, the encoder 304, the base signal generator 306, and the control circuitry 308 are similar to their counterparts in the example of FIG. 3. Elements numbered with like reference numbers are substantially similar and/or identical and, thus, are not redescribed in detail here. Instead, the interested reader is referred to the above descriptions of the like numbered elements for a full and complete description of the same.

The remote control 102 of the illustrated example responds to an identifier selected and/or input by the user 104 by transmitting an audio signal to a meter (e.g., the meter 110) in a manner similar to the remote control 102 of FIG. 3. The identifier received from the user is associated with an identification code via the code database 302 (see FIG. 3A). The encoder 304 encodes the people identification code into a base signal generated by the base signal generator 306 and the encoded signal is transmitted by the audio transmitter 206 and the speaker 208.

In the illustrated example, the remote control 102 includes the sensor 402, the decoder 404, and the timer 406 to instruct the transmitter 206 to transmit the generated audio signals at a time when media identification codes are not expected in signals at the media presentation device 108. In the illustrated example, the meter 110 obtains signals from the media presentation device 108 and attempts to detect media identification codes (e.g., watermarks, ancillary codes, etc.) carried in the signal that may be used to identify media and/or a source of media presented by the media presentation device 108. Thus, the meter 110 may receive coded signals from either the remote control 102 or the media presentation device 108. To avoid and/or prevent interference between the media identification codes of the media content and the people identification codes sent by the remote control 102, the remote control 102 of the illustrated example determines when media identification codes are expected in the media (e.g., identifies the periodicity of the codes in the media) and only transmits the encoded people identification audio signal containing a person identification code at a time when a media identification code is not expected to be present in the media (e.g., the audio signal) output by the media presentation device 108.

The sensor 402 of the illustrated example senses (e.g., receives) free field audio signals (e.g., audio signals propagating in the monitored environment and output by, for example, a speaker of the media presentation device 108). The sensor 402 passes received signals to the decoder 404. The decoder 404 of the illustrated example decodes the received signal to determine whether media identification codes are present in the signal. If media identification codes are present in the signal, the timer 406 of the illustrated example determines a time interval at which media identification codes are not expected. For example, a media identification code (e.g., a code in a signal output by the media presentation device 108) may be present in the received signal every 2.5 seconds. In such an example, the timer 406 instructs the audio transmitter 206 to transmit a generated audio signal containing a person identification code (e.g., identifying the user 104) during the time interval when a media identification code is not expected (e.g., in the 2.5 second interval between the times of the media identification codes).

The control circuitry 308 of the illustrated example controls the operations of the remote control 102. For example, the control circuitry 308 controls and/or responds to the input 202, the audio transmitter 206, the code database 302, and the encoder 304 to allow the user 104 to input the identifier(s) and to transmit audio signal(s) representative of identifier(s).

While an example remote control 102 has been illustrated in FIG. 4, one or more of the elements, processes and/or devices illustrated in FIG. 4 may be combined, divided, re-arranged, omitted, eliminated and/or implemented in any other way. Further, the input 202, the audio transmitter 206, the speaker 208, the remote control circuitry 212, the code database 302, the encoder 304, the base signal generator 306, the control circuitry 308, the sensor 402, the decoder 404, the timer 406, and/or, more generally, the example remote control 102 of FIG. 4 may be implemented by hardware, software, firmware and/or any combination of hardware, software and/or firmware. Thus, for example, any of the example input 202, the audio transmitter 206, the speaker 208, the remote control circuitry 212, the code database 302, the encoder 304, the base signal generator 306, the control circuitry 308, the sensor 402, the decoder 404, the timer 406, and/or, more generally, the example remote control 102 of FIG. 4 could be implemented by one or more circuit(s), programmable processor(s), ASIC(s), PLD(s) and/or FPLD(s), etc. When any of the apparatus or system claims of this patent are read to cover a purely software and/or firmware implementation, at least one of the example input 202, the audio transmitter 206, the speaker 208, the remote control circuitry 212, the code database 302, the encoder 304, the base signal generator 306, the control circuitry 308, the sensor 402, the decoder 404, and/or the timer 406 are hereby expressly defined to include a tangible computer readable medium such as a memory, DVD, CD, Blu-ray, etc. storing the software and/or firmware. Further still, the example remote control 102 of FIG. 4 may include one or more elements, processes and/or devices in addition to, or instead of, those illustrated in FIG. 4, and/or may include more than one of any or all of the illustrated elements, processes and devices.

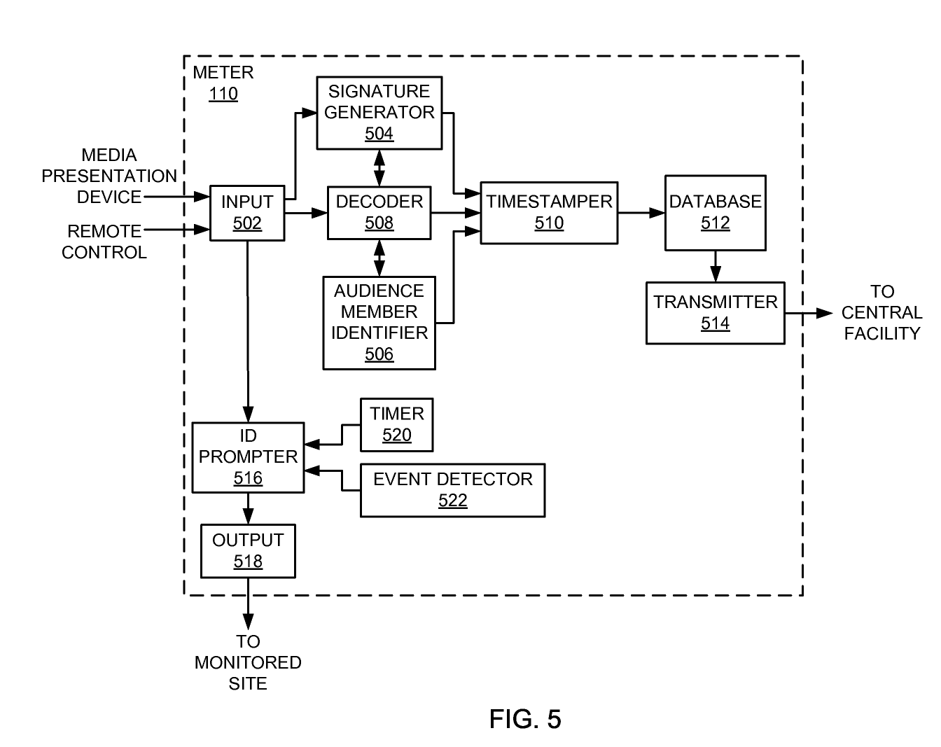

FIG. 5 is a block diagram of an example implementation of the meter 110 of FIG. 1. The meter 110 of the illustrated example is used to collect, aggregate, locally process, and/or transfer audience measurement data collected at a monitored site (e.g., the monitored site 106) to a central data facility (e.g., the central data facility 112). In the illustrated example, the meter 110 is used to collect media identification data from a media presentation device (e.g., the media presentation device 108). The meter 110 of the illustrated example also prompts a user (e.g., the user 104) to input an identifier via a remote control (e.g., the remote control 102 of FIGS. 1, 2, 3, and/or 4) and analyzes audio signals received from the remote control 102 to determine the identity of the user 104. The meter 110 of the illustrated example includes an input 502 (e.g., a microphone), a signature generator 504, an audience member identifier 506, a decoder 508, a timestamper 510, a database 512, a transmitter 514, an identification prompter 516, an output 518, a timer 520, and an event detector 522.

The input 502 of the illustrated example receives signals transmitted from the remote control 102 and/or the media presentation device 108. While one input 502 is shown in the illustrated example, a plurality of inputs may be used to receive signals. The input 502 of the illustrated example is implemented by a microphone to receive audio signals from the remote control 102 and/or the media presentation device 108. In some examples, the input 502 receives audio signals from the media presentation device 108 via a wired connection and/or wirelessly. The input 502 of the illustrated example passes received signals to the signature generator 504 and/or the audience member identifier 506.

The signature generator 504 and the decoder 508 of the illustrated example are used to generate signatures and/or extract codes from data and/or signals collected by the input 502. Codes, such as watermarks, ancillary codes, etc. may be embedded within or otherwise transmitted with media signals obtained from the media presentation device 108 to uniquely identify broadcasters and/or media (e.g., content and/or advertisements). Signatures are a representation of at least one characteristic of a media signal (e.g., a characteristic of the frequency spectrum of the signal). Signatures are typically not dependent upon insertion of codes in the media, but instead reflect an inherent characteristic of the media and/or the media signal. The decoder 508 analyzes the signal to extract codes to identify broadcasters, channels, stations, and/or programs. The signature generator 504 analyzes the signal to generate a signature thereof. Any method of decoding may be used by the decoder 508 to extract codes and/or any method of signature generation may be used by the signature generator 504 to generate signatures. The extracted media identification codes and/or generated signatures are passed to the timestamper 510.

The timestamper 510 of the illustrated example timestamps the media identification code(s) and/or signature(s) and passes the timestamped media identification code(s) and/or signature(s) to the database 512 for storage. The storage may be a temporary store (e.g., a cache or buffer) or may be a longer term storage. The database 512 passes the timestamped media identification code(s) and/or signature(s) to the transmitter 514. The transmitter 514 of the illustrated example transmits the media identification code(s) and/or signature(s) to the central facility 112 via the network 114 for further processing.

The audience member identifier 506 of the illustrated example is used to identify an audience member (e.g., the user 104) to be associated with the media identification code(s) and/or signature(s) collected by the meter. As described above with reference to FIGS. 2-4, the remote control 102 transmits audio signals using DTMF signals representative of an identifier of the user 104 or transmits audio signals embedded with a watermark representative of an identifier of the user 104. The audio signals received from the remote control 102 are decoded by the decoder 508 (or a second decoder) to extract any identifiers represented by watermarks or to extract any identifiers represented by the DTMF tones. The extracted identifier(s) are passed to the audience member identifier 506 of the illustrated example. The audience member identifier 506 uses the identifier(s) to determine the identity(ies) of the user(s) 104 by accessing, for example, the lookup table of FIG. 3A.

Once the audience member identifier 506 has determined the identifier(s) and/or the identifier(s) of the associated audience member(s), the audience member identifier 506 of the illustrated example passes this people identification information to the timestamper 510.

The timestamper 510 timestamps the people identification information and the database 512 stores the timestamped people identification information. The transmitter 514 of the illustrated example transmits the timestamped people identification information (e.g., the people identification code(s), the identifier(s), and/or the associated audience member identity(ies)) to the central facility 112 for further processing (e.g., the audience member may be associated with the collected media identification data via the timestamper 510 which shows which media was presented at which time and which audience member was presented at which time).

The identification prompter 516 of the illustrated example is used to prompt a user to input and/or select one or more identifiers via the remote control 102. As mentioned above, specific identifiers identify specific persons. Thus, if more than one person is present, more than one identifier will be selected and/or entered to identify each person in the local audience. To prompt a user, the identification prompter 516 instructs the output 518 to output a user prompt. A user prompt may be, for example, an audible audio signal with instructions prompting the user(s), flashing LEDs, a combination of an audible signal and flashing LEDs, and/or any other output indicating that user response is requested. Thus, the output 518 may be a speaker, LEDs, a combination of a speaker and LEDs, a vibration device, and/or any other device capable of indicating that a user response is requested.

The identification prompter 516 of the illustrated example uses the timer 520 and/or the event detector 522 to determine when to prompt user(s) to enter identifier(s). The identification prompter 516 uses the timer 520 to prompt the user(s) periodically and/or aperiodically. For example, the timer 520 may be used to prompt the user(s) at least a predetermined time interval (e.g., every thirty minutes) since the last prompt. The identification prompter 516 uses the event detector 522 to prompt the user(s) upon an occurrence of some event. The event detector 522 detects, for example, a change in a television channel, a change in television volume, a connection of a gaming device, a change of source, etc. The event detector 522 may detect any event that may indicate that the composition of the audience has changed. For example, the event detector 522 may count persons in the room and prompt when a change has occurred as explained in U.S. Pat. No. 7,609,853, which is hereby incorporated herein by reference. The identification prompter 516 may prompt the audience to self-identify based on the timer 520, based on the event detector 522, and/or based on a combination of both the timer 520 and the event detector 522.

Once the identification prompter 516 has prompted the audience to self-identify (e.g., enter identifiers from the person(s) present in the room), the identification prompter 516 of the illustrated example provides a confirmation to the audience that the identifier(s) have been received. For example, once the meter 110 identifies a user based on a signal from the remote control 102, the identification prompter 516 instructs the output 518 to output a confirmation to the user. The confirmation is different from the user prompt, for example, a different audible signal, different flashing LEDs, different jingle, etc.

While an example meter 110 has been illustrated in FIG. 5, one or more of the elements, processes and/or devices illustrated in FIG. 5 may be combined, divided, re-arranged, omitted, eliminated and/or implemented in any other way. Further the input 502, the signature generator 504, the audience member identifier 506, the decoder 508, the timestamper 510, the database 512, the transmitter 514, the identification prompter 516, the output 518, the timer 520, the event detector 522, and/or, more generally, the example meter 110 of FIG. 5 may be implemented by hardware, software, firmware and/or any combination of hardware, software and/or firmware. Thus, for example, any of the example input 502, the signature generator 504, the audience member identifier 506, the decoder 508, the timestamper 510, the database 512, the transmitter 514, the identification prompter 516, the output 518, the timer 520, the event detector 522, and/or, more generally, the example meter 110 of FIG. 5 could be implemented by one or more circuit(s), programmable processor(s), ASIC(s), PLD(s) and/or FPLD(s), etc. When any of the apparatus or system claims of this patent are read to cover a purely software and/or firmware implementation, at least one of the example input 502, the signature generator 504, the audience member identifier 506, the decoder 508, the timestamper 510, the database 512, the transmitter 514, the identification prompter 516, the output 518, the timer 520, the event detector 522, and/or the meter 110 are hereby expressly defined to include a tangible computer readable medium such as a memory, DVD, CD, Blu-ray, etc. storing the software and/or firmware. Further still, the example meter 110 of FIG. 5 may include one or more elements, processes and/or devices in addition to, or instead of, those illustrated in FIG. 5, and/or may include more than one of any or all of the illustrated elements, processes and devices.

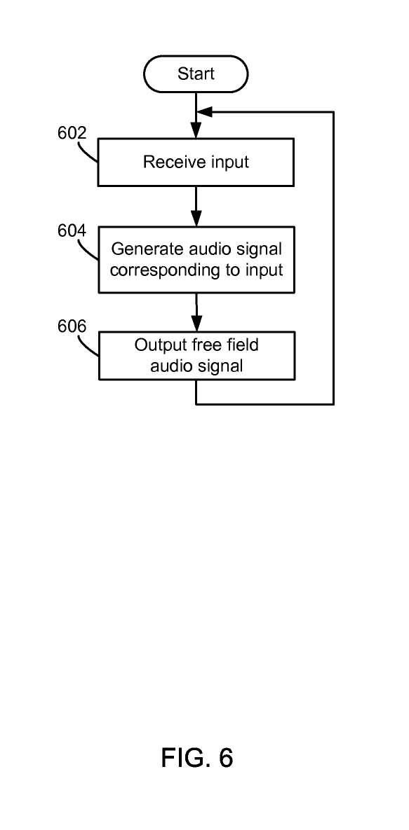

Flowcharts representative of example machine readable instructions for implementing the example remote control 102 of FIGS. 2, 3, and 4 and the example meter 110 of FIG. 5 are shown in FIGS. 6, 7, 8, 9, and 10. In these examples, the machine readable instructions comprise a program for execution by a processor such as the processor 1112 shown in the example processor platform 1100 discussed below in connection with FIG. 11. The program may be embodied in software stored on a tangible computer readable storage medium such as a compact disc read-only memory (“CD-ROM”), a floppy disk, a hard drive, a DVD, Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowcharts illustrated in FIGS. 6, 7, 8, 9 and 10, many other methods of implementing the example remote control 102 and/or the example meter 110 may alternatively be used. For example, the order of execution of the blocks may be changed, and/or some of the blocks described may be changed, eliminated, or combined.

As mentioned above, the example processes of FIGS. 6, 7, 8, 9, and 10 may be implemented using coded instructions (e.g., computer readable instructions) stored on a tangible computer readable storage medium such as a hard disk drive, a flash memory, a read-only memory (“ROM”), a CD, a DVD, a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 6, 7, 8, 9 and 10 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 6 is a flow diagram representative of example machine readable instructions that may be executed to implement the example remote control 102 of FIG. 2. In the example of FIGS. 2 and 6, the remote control 102 utilizes DTMF signals to transmit people identification information.

Initially, the input 202 of the illustrated example receives an identifier entered by the user 104 (block 602). The identifier is then passed to the audio signal generator 204. The audio signal generator 204 of the illustrated example generates an audio signal corresponding to the input received at the input 202 (block 604). In the illustrated example, a DTMF signal representative of the identifier is mixed with a carrier wave.

The signal output by the audio signal generator 204 is transmitted by the audio transmitter 206 of the illustrated example (block 606). The audio transmitter 206 of the illustrated example is a speaker to transmit the audio signals as a free field audio signal to be received at the meter 110. Control then returns to block 602.

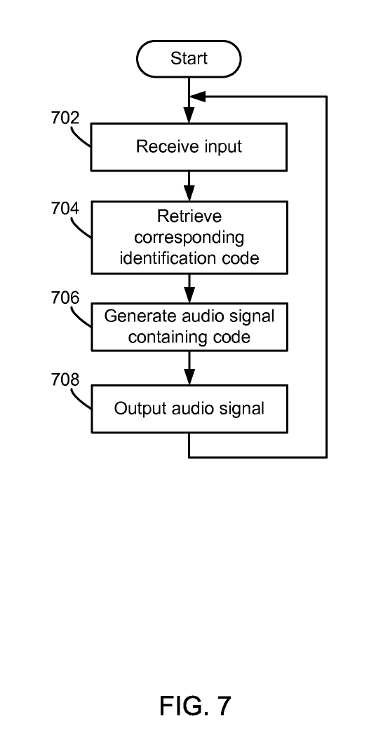

FIG. 7 is a flow diagram representative of example machine readable instructions that may be executed to implement the example remote control 102 of FIG. 3. The remote control 102 of the illustrated example uses watermarking technology to transmit people identification data.

Initially, the input 202 of the illustrated example receives an identifier from the user 104 (block 702). The identifier is used to access the code database 302. The code database 302 of the illustrated example outputs an identification code that corresponds to the identifier entered by the user 104 (block 704). This identification code is passed to the encoder 304.

The encoder 304 of the illustrated example generates an audio signal containing the identification code (block 706). The encoder 304 encodes (e.g., inserts) the identification code into a baseband audio signal that is obtained from the base signal generator 306. In the illustrated example, the baseband signal is a white noise signal (e.g., a random carrier signal with a full spectrum of frequency components capable of masking the code to reduce the likelihood of the code being perceptible to the user). The watermarked signal (e.g., an audio signal containing the identification code) is passed to the audio transmitter 206. The audio transmitter 206 of the illustrated example outputs the watermarked audio signal (block 708) as a free field audio signal via, for example, a speaker. Control then returns to block 702.

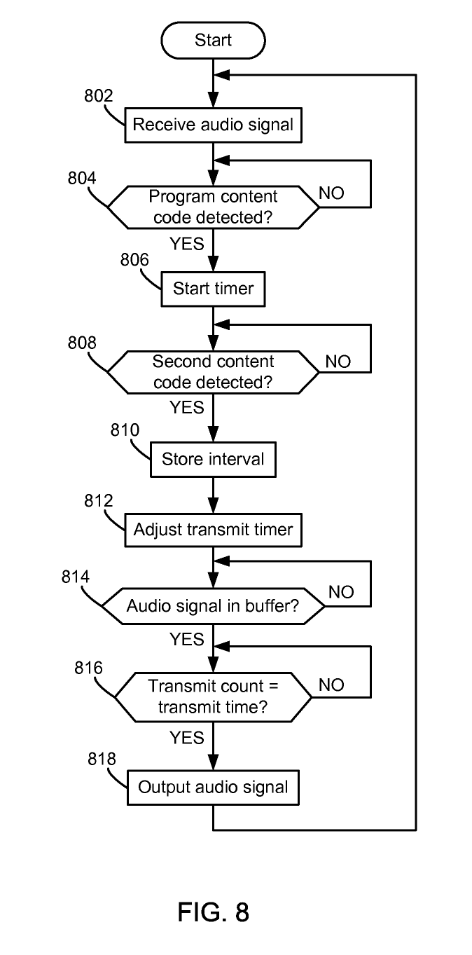

FIG. 8 is a flow diagram representative of example machine readable instructions that may be executed to implement the example remote control 102 of FIG. 4. The example remote control 102 of FIG. 4 detects the presence of media identification codes in signals output at a media presentation device (e.g., the media presentation device 108) and transmits people identifier data at times which do not conflict with the media identification codes. In particular, in the illustrated example, the remote control 102 transmits audio signals at a time when media identification codes are not expected to be in signals output by the media presentation device 108.

To this end, the sensor 402 of the illustrated example collects a free field audio signal (e.g., signals output by the media presentation device 108) (block 802) and passes the received signal to the decoder 404. The decoder 404 of the illustrated example decodes the received signal to detect the presence of media identification codes in the signal (block 804). Control remains at block 804 until media identification codes are detected. If media identification codes are present in the signal, the timer 406 of the illustrated example is tripped until the next media identification code is detected to determine times at which media identification codes are expected and the interval between such times (block 806). For example, a media identification code (e.g., a code in a signal output by the media presentation device 108) may be present in the received signal every 2.5 seconds. The timer 406 of the illustrated example sets a timer when a first media identification code is detected (block 806) and the timer runs until a second media identification code is detected in the signal (block 808). Once the second media identification code is detected, the decoder 404 stores the time interval between media identification codes (block 810). The decoder 404 then adjusts a transmit timer based on this time interval (block 812). The transmit timer is a timer that counts out the time interval. The transmit time may be, for example, equal to half of the interval count. Adjusting the transmit timer may involve adjusting the length of the count of the transmit timer and aligning the start time of the transmit timer with the detected time of a media identification code. The adjustments to the interval may be based on a running average of the interval time results. The audio transmitter 206 determines if an audio signal has been buffered (e.g., if an audio signal has been generated containing a people identification code) (block 814). Once the audio signal has been generated, the audio transmitter 206 determines if the transmit count is equal to the transmit time (block 816). Once the transmit count reaches the transmit time set by the transmit timer (e.g., the time at which media identification codes are not expected), the audio transmitter 206 outputs the audio signal via the speaker 208 (block 818). Control then returns to block 802.

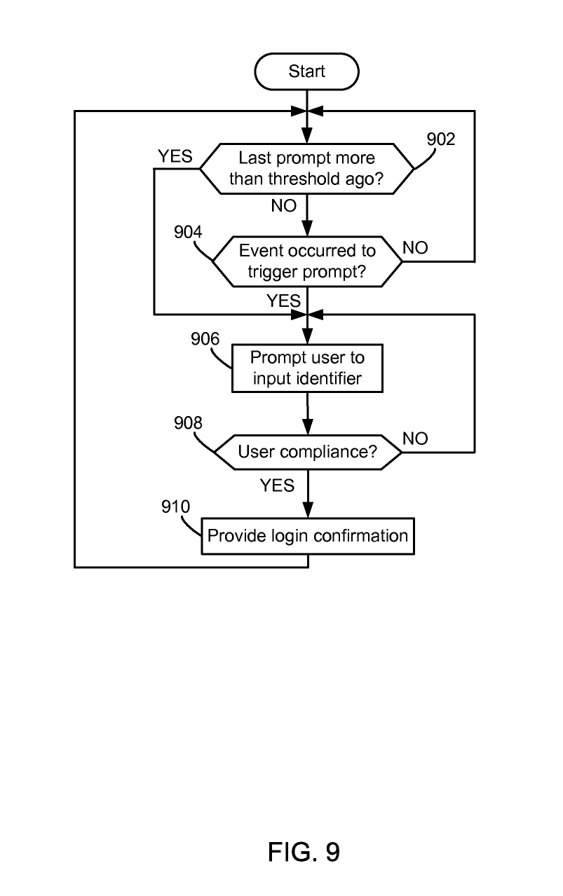

FIG. 9 is a flow diagram representative of example machine readable instructions that may be executed to implement the example meter 110 of FIG. 5 to prompt persons in the monitored area to self-identify using the remote control 102. Initially, the identification prompter 516 of the illustrated example determines if persons have been prompted to enter an identifier more than a threshold period of time ago (block 902). In the illustrated example, the identification prompter 516 uses the timer 520 to determine if the threshold has been exceeded. For example, the timer 520 may be set so that the identification prompter 516 prompt(s) a user every thirty minutes. If the threshold time has not been exceeded, the identification prompter 516 uses the event detector 522 to determine if an event has occurred to trigger a prompt (block 904). For example, the identification prompter 516 may provide a prompt when the event detector 522 detects a change in a television channel, a change in television volume, a connection of a gaming device, etc. If no event has occurred to trigger a prompt, control returns to block 902. If the last prompt was more than the threshold time ago or an event has occurred to trigger a prompt, the identification prompter 516 prompts persons in the monitored area via the output 518 to enter an identifier (block 906). The identification prompter 516 then determines if there has been user compliance with the prompt (e.g., if a person has entered an identifier via the input 502) (block 908). User compliance may be verified by comparing the number of identifiers received to the number of persons counted (e.g., from an image) in the room as in U.S. Pat. No. 7,609,853. If there has not been user compliance, control returns to block 906. If there has been user compliance (e.g., an identifier has been entered), the identification prompter 516 provides a login confirmation to the user (block 910) and control returns to block 902.

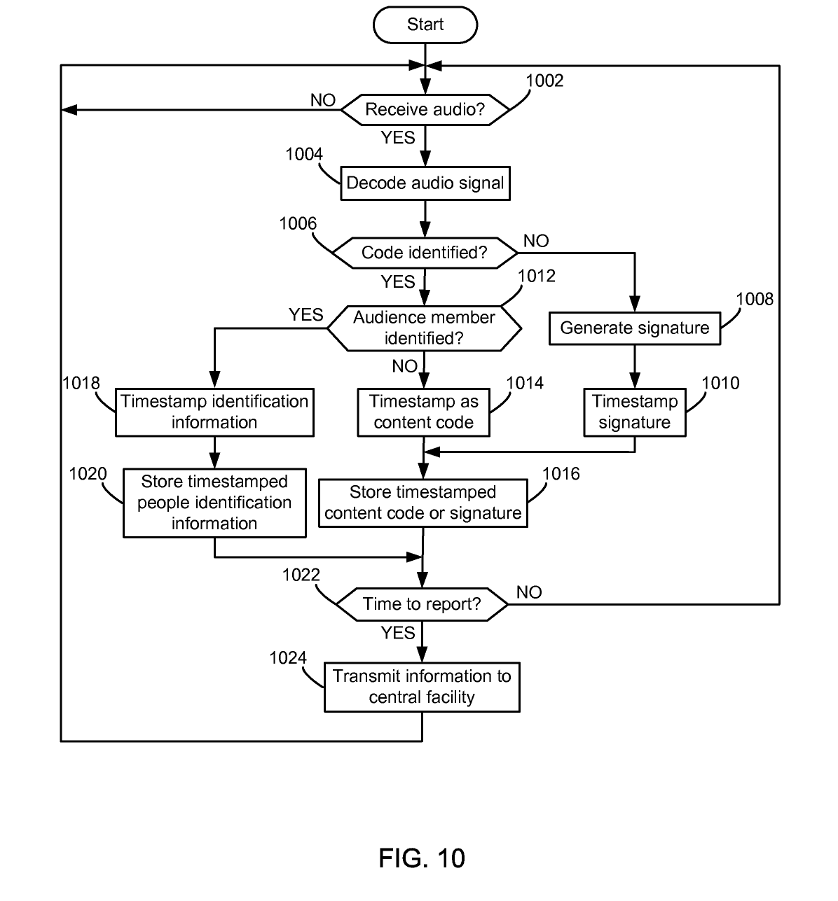

FIG. 10 is a flow diagram representative of example machine readable instructions that may be executed to implement the example meter 110 of FIG. 5. Initially, the meter 110 determines if an audio signal has been received via the input 502 (block 1002). Control remains at block 1002 until an audio signal is received. Once an audio signal is received at the input 502, the decoder 508 decodes the audio signal (block 1004) to identify codes in the audio signal (block 1006). If codes are not identified in the audio signal, the signature generator 504 generates a signature representative of a characteristic of the audio signal (block 1008) and the timestamper 510 timestamps the generated signature (block 1010). If a code is identified in the decoded audio signal, the audience member identifier 506 determines if the code is representative of an audience member (e.g., the code represents a person identifier) (block 1012). If the code does not identify an audience member, the code is timestamped by the timestamper 510 as a media identification code (e.g., the code represents media) (block 1014). The database 512 then stores timestamped media identification codes and/or signatures (block 1016). If the audience member identifier 506 identifies an audience member using the code, the timestamper 510 timestamps the people identification information (block 1018). The database 512 then stores the timestamped people identification information (block 1020). The transmitter 514 then determines if it time to report the collected information to a central facility (block 1022). The transmitter 514 may transmit collected information every thirty minutes, for example, and/or in response to an event as explained above. If it is not time to report, control returns to block 1002 and the meter 110 continues to collect information. If it is time to report, the transmitter 514 transmits the information to the central facility (block 1024). Control then returns to block 1002.

FIG. 11 is a block diagram of an example processor platform 1100 capable of executing the instructions of FIGS. 6, 7, 8, 9, and/or 10 to implement the example remote control 102 of FIGS. 2, 3, and/or 4, the example meter 110 of FIG. 5, and/or the system of FIG. 1. The processor platform 1100 can be, for example, a server, a personal computer, an Internet appliance, a set top box, or any other type of computing device.

The processor platform 1100 of the instant example includes a processor 1112. For example, the processor 1112 can be implemented by one or more microprocessors or controllers from any desired family or manufacturer. The processor 1112 includes a local memory 1113 (e.g., a cache) and is in communication with a main memory including a volatile memory 1114 and a non-volatile memory 1216 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 also includes an interface circuit 1120. The interface circuit 1120 may be implemented by any type of interface standard, such as an Ethernet interface, a universal serial bus (USB), and/or a PCI express interface.

One or more input devices 1122 are connected to the interface circuit 1120. The input device(s) 1122 permit a user to enter data and commands into the processor 1112. The input device(s) can be implemented by, for example, a keyboard, a mouse, a touchscreen, a track-pad, a trackball, isopoint and/or a voice recognition system.

One or more output devices 1124 are also connected to the interface circuit 1120. The output devices 1124 can be implemented, for example, by display devices (e.g., a liquid crystal display, a cathode ray tube display (CRT), etc.). The interface circuit 1120, thus, typically includes a graphics driver card.

The interface circuit 1120 also includes a communication device such as a modem or network interface card to facilitate exchange of data with external computers via a network 1126 (e.g., an Ethernet connection, a digital subscriber line (DSL), a telephone line, coaxial cable, a cellular telephone system, etc.).

The processor platform 1100 also includes one or more mass storage devices 1128 for storing software and data. Examples of such mass storage devices 1128 include floppy disk drives, hard drive disks, compact disk drives and digital versatile disk (DVD) drives. The mass storage device 1128 may implement a local storage device.

The coded instructions 1132 of FIGS. 6, 7, 8, 9, and/or 10 may be stored in the mass storage device 1128, in the local memory 113, in the volatile memory 1114, in the non-volatile memory 1116, and/or on a removable storage medium such as a CD or DVD.

From the foregoing, it will be appreciated that example remote controls that function as people meters have been disclosed. Such example remote controls are able to control consumer electronic devices and are, thus, likely to be near at hand to at least one audience member. Thus, when the system prompts the audience to self-identify, one or more members of the audience can enter or select identifiers corresponding to the persons present in the area (e.g., key in a numeric identifier, select a button corresponding to a user, etc.). The remote control generates an audio signal that transmits the identifier(s) to a meter collecting audience measurement information. Because the meter of some examples is already adapted to listen for codes in audio signals to identify media presented in the monitored area, the meter is likewise able to decode the person identifier information transmitted by the remote control.

In some examples, the transmitted people identifier information is created by the remote control by modulating the identifier information into a baseband signal having the characteristics of a white noise signal. The white noise signal contains a full spectrum of frequency components and, thus, reduces the likelihood of the people identifier being perceptible to an audience.

While some examples disclosed herein may be used to transmit audience identifiers, any other information may be additionally or alternatively transmitted. For example, content identifiers, location identifiers, content evaluations, content selections, trivia answers, etc. may be transmitted using some examples disclosed herein. While some examples disclosed herein utilize a remote control to transmit audience identifiers, any other device may additionally or alternatively used. For example, a computing device, a smartphone, a tablet, a keyboard, etc. may be used to transmit audience identifiers and/or other information. Audio signals described herein provide an interface between a variety of metering devices to provide and/or exchange identifiers and/or information.

Although certain example methods, systems, apparatus, and articles of manufacture have been described herein, the scope of coverage of this patent is not limited thereto. On the contrary, this patent covers all methods, systems and articles of manufacture fairly falling within the scope of the claims of this patent.

1.-4. (canceled)

5. A method of identifying an audience member comprising:
detecting selection of an identification key on a people meter, the identification key being input by a user using an input device on the people meter;
generating a free field audio signal to identify the user based on the identification key; and
transmitting the free field audio signal via a speaker of the people meter.

6. The method of claim 5, wherein the people meter is a remote control.

7. The method of claim 5, wherein the free field audio signal is a dual-tone multi-frequency (“DTMF”) signal.

8. The method of claim 5, wherein the free field audio signal is transmitted to a meter, the meter collecting media exposure data associated with a media presentation device.

9. The method of claim 5, further comprising prompting the user to input the identification key via at least one of a second audio signal or a light-emitting diode (“LED”).

10. The method of claim 5, further comprising providing a login confirmation to the user when the user inputs the identification key.

11.-20. (canceled)

21. A system of identifying an audience member comprising:
a people meter to:
detect an input by a user;
generate a free field audio signal to identify the user based on an identification key corresponding to the input; and
transmit the free field audio signal via a speaker.

22. The system of claim 21, wherein the people meter is a remote control.

23. The system of claim 21, wherein the free field audio signal is a dual-tone multi-frequency (“DTMF”) signal.

24. The system of claim 21, wherein the free field audio signal is transmitted to a meter, the meter to collect media exposure data associated with a media presentation device.

25. The system of claim 24, wherein the meter is to prompt the user to input the identification key via at least one of a second audio signal or a light-emitting diode (“LED”).

26. The system of claim 25, wherein the meter is to provide a login confirmation to the user when the user inputs the identification key.

27.-34. (canceled)

35. A tangible computer-readable storage medium comprising instructions that, when executed, cause a computing device to at least:
detect selection of an identification key on a people meter, the identification key being input by a user using an input device on the people meter;
generate a free field audio signal to identify the user based on the identification key; and
transmit the free field audio signal via a speaker of the people meter.

36. The computer-readable medium of claim 35, wherein the people meter is a remote control.

37. The computer-readable medium of claim 35, wherein the free field audio signal is a dual-tone multi-frequency (“DTMF”) signal.

38. The computer-readable medium of claim 35, wherein the free field audio signal is transmitted to a meter, the meter collecting media exposure data associated with a media presentation device.

39.-44. (canceled)
